(19) United States
(12) Patent Application Publication
(10) Pub. No.: US 2008/0156589 A1
(43) Pub. Date: Jul. 3, 2008

(54) Lifting Platform for the Maintenance and Repair of Light Vehicles

(75) Inventor: Jean-Luc Marchand, Les Landes Genusson (FR)

Correspondence Address: YOUNG & THOMPSON, 209 Madison Street, Suite 500, ALEXANDRIA, VA, 22314, US

(73) Assignee: MAROLOTEST, CHOLET (FR)

(21) Appl. No.: 11/884,487

(22) PCT Filed: Jan. 27, 2006
(86) PCT No.: PCT/FR06/00196

§ 371 Date: Aug. 16, 2007

(30) Foreign Application Priority Data
Feb. 23, 2005 (FR) 0501821

(51) Int. Cl. B66F 7/28

(52) U.S. Cl. 187/219

(57) ABSTRACT

A lifting platform (1) for the maintenance and repair of light vehicles, such as quad bikes, motorcycles, lawn mower tractors or the like, of the type including a load-bearing platform and a lift mechanism (2) that acts on the load-bearing platform, whereby the load-bearing platform, with a longitudinal axis that is viewed in the direction of movement of a vehicle on the surface of the platform, comes in the form of a number of decks (3, 4, 5) that work with a support chassis (6). This platform is characterized in that the decks (3, 4, 5) of the load-bearing platform are mobile decks (3, 4, 5), optionally removable, sliding on the chassis (6) in a direction that is orthogonal or transverse to the longitudinal axis of the platform to constitute an adjustable surface support area.

This invention relates to a lifting platform for the maintenance and repair of light vehicles, such as quad bikes, motorcycles, lawn mower tractors or the like, of the type comprising a load-bearing platform and a lift mechanism that acts on said load-bearing platform.

Such platforms are well known to one skilled in the art. Today, they are widely used for working on light vehicles, such as quad bikes, motorcycles, lawn mower tractors or the like. The tendency today is to use a specialized platform that is either dedicated to working on motorcycles or on quad bikes because the platform widths that are necessary for accommodating vehicles are different for a motorcycle or a quad bike. In general, the tables for motorcycles have platform dimensions with a width that is close to 750 mm while the tables for quad bikes, rototillers, microtractors, miniature cars or the like have a width that is close to 1,300 mm.

Attempts have, however, been developed for the production of polyvalent platforms. The solutions offered are not completely satisfactory. One proposed solution on the market consists in attaching—along the longitudinal edges of the platform whose dimensions correspond to those that are necessary for accommodating a narrow engine, such as a motorcycle engine—blocks that make it possible to increase the surface area of the platform for accommodating a wide engine. However, in this case, a full surface area is formed that makes it difficult to work under the wide engine. Actually, even if the operator works with outstretched arms, he has many difficulties in accessing the median portion of the bottom of the wide engine. Such a solution is described in, for example, the document DE-U-29815973.

U.S. Pat. No. 6,345,693 describes another embodiment of a lifting platform, in particular for motorcycles. This platform comprises a platform that has a cut-out, inside of which a sliding deck, which can itself be connected to a ramp, can be inserted. In this document, the platform does not come in the form of a number of decks that work with a support chassis on which the decks are mounted to slide but simply in the form of a platform that consists of at least two decks, one stationary and the other slide-mounted on the stationary deck in a direction that is parallel to the longitudinal axis of the stationary deck. The absence of a support chassis limits the possibilities for modifying the surface area of the platform and, in particular, the possibilities for access to the inside of said platform. Finally, this arrangement does not make it possible to clear space for access for the operator around said platform in the case of a narrow engine.

The European Patent EP-A-0,297,632 describes a hollow chassis and decks removably mounted on said chasses. These decks are not mounted to slide on said chassis. Actually, these decks are equipped with hooks allowing their attachment to said chassis as the figures illustrate. Sliding is prevented because of the configuration of the decks and the interruption of the rail of the central chassis that is designed to accommodate said decks. Consequently, again, it is not possible to clear, by moving the decks, access to the inside of said platform or around said platform.

The documents U.S. Pat. No. 6,695,287 and JP 2004/323181 are part of the technological background.

One object of this invention is therefore to propose a polyvalent lifting platform whose design allows the operator to intervene without difficulty on wide or narrow engines.

Another object of this invention is to propose a lifting platform whose design of the load-bearing platform makes it possible to occupy two positions: one, with a small width requirement, suitable for narrow engines, and the other, with greater width requirement, suitable for large engines.

For this purpose, the invention has as its object a lifting platform for the maintenance and repair of light vehicles, such as quad bikes, motorcycles, lawn mower tractors or the like, of the type comprising a load-bearing platform and a lift mechanism that acts on said load-bearing platform, whereby said load-bearing platform with a longitudinal axis, viewed from the direction of movement of a vehicle to the surface of said platform, comes in the form of a number of decks that work with a support chassis, characterized in that the decks of the load-bearing platform are mobile decks, optionally removable, sliding on said chassis in a direction that is orthogonal or transverse to the longitudinal axis of said platform to constitute an adjustable surface support area.

Thanks to the design of the platform in the form of a number, namely at least two, sliding decks, it is possible to increase the width of the platform by clearing in parallel access spaces inside the platform in the case of working on wide engines or, conversely, reducing to a minimum the width of said platform to make it possible to clear access space around said platform, thus allowing work on narrow engines or zero-size engines. Such a lifting platform then becomes a polyvalent platform that can accommodate any type of light engine, regardless of the gauge of said engine, whereby the platform can vary in width inside a range of in general between 750 mm and 1,500 mm. It should be recalled that gauge is defined as the transverse distance between the wheels of the same axle on a vehicle, whereby this gauge is regarded as having a value that is equal to zero for a motorcycle.

Thus, according to a preferred embodiment of the invention, the decks work with the support chassis to bring about, during their movement, parallel to a variation of the overall width of the platform, the clearing of spaces for the access of the operator either around said platform or inside the platform, based on the location of areas for working on the engine. The decks therefore work with the support chassis to bring about, either parallel to the increase in the width of the platform, the clearing of space inside the platform, or, parallel to the reduction in the width of the platform, the clearing of space around said platform.

The invention will be better understood from reading the following description of embodiments, with reference to the accompanying drawings, in which:

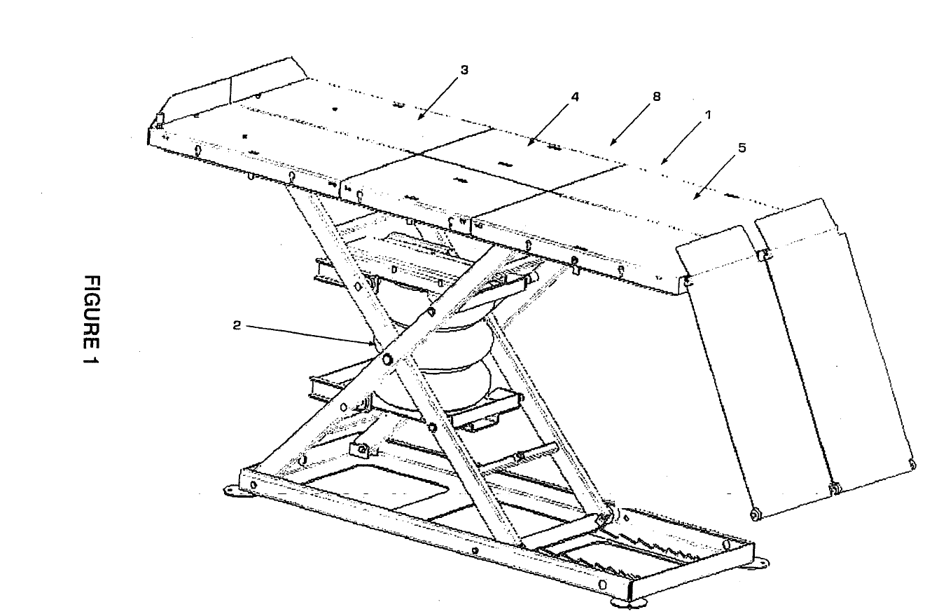

FIG. 1 shows a perspective view of a lifting platform according to the invention in the more compact position of the decks for accommodating narrow engines;

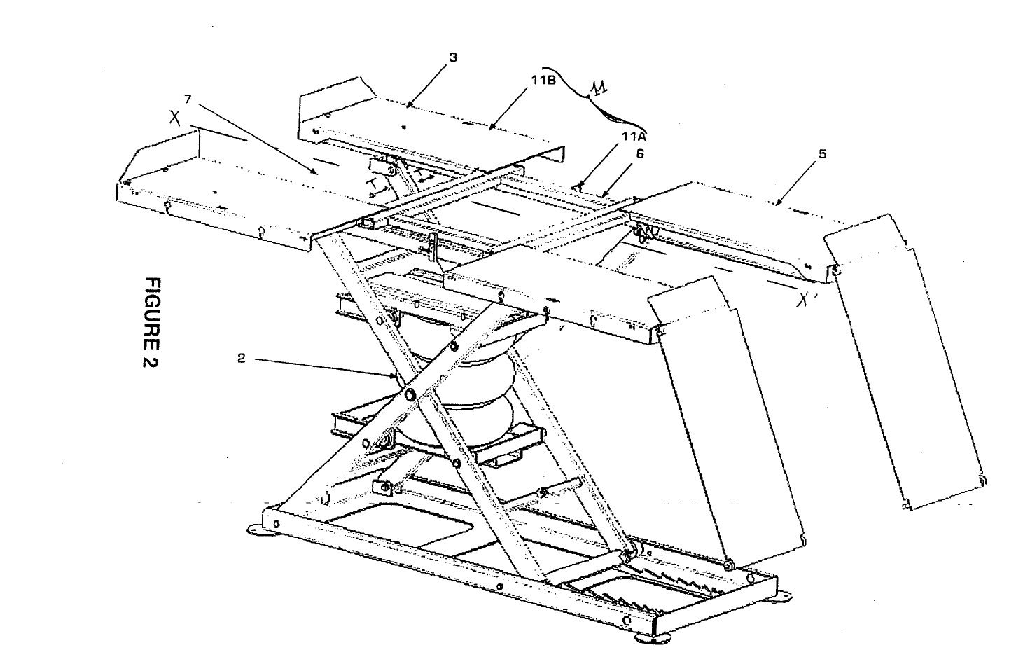

FIG. 2 shows a perspective view of a lifting platform according to the invention in a more spacious position, whereby the decks that constitute the median part of the platform have been removed;

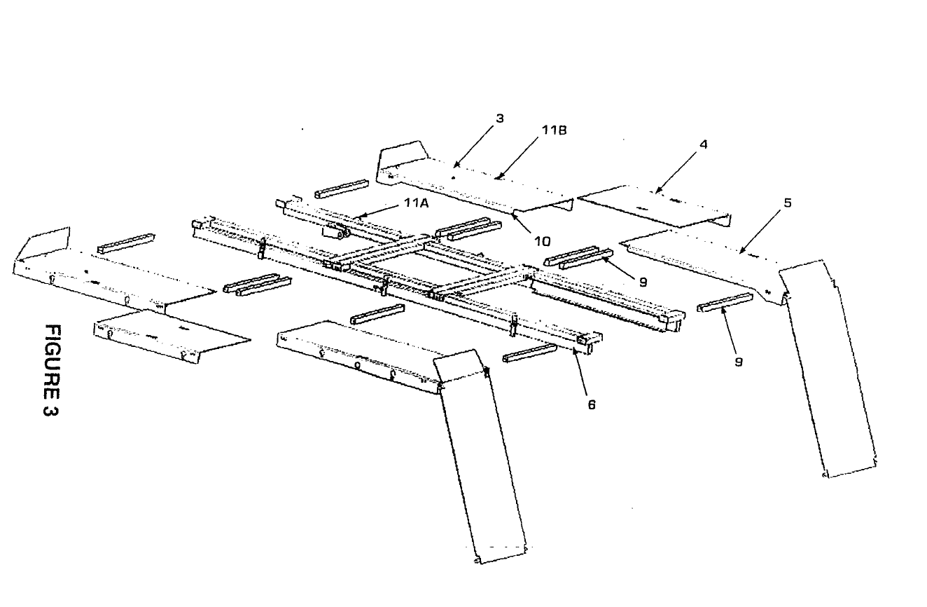

FIG. 3 shows a view, in exploded position of the elements that constitute it, of the load-bearing platform;

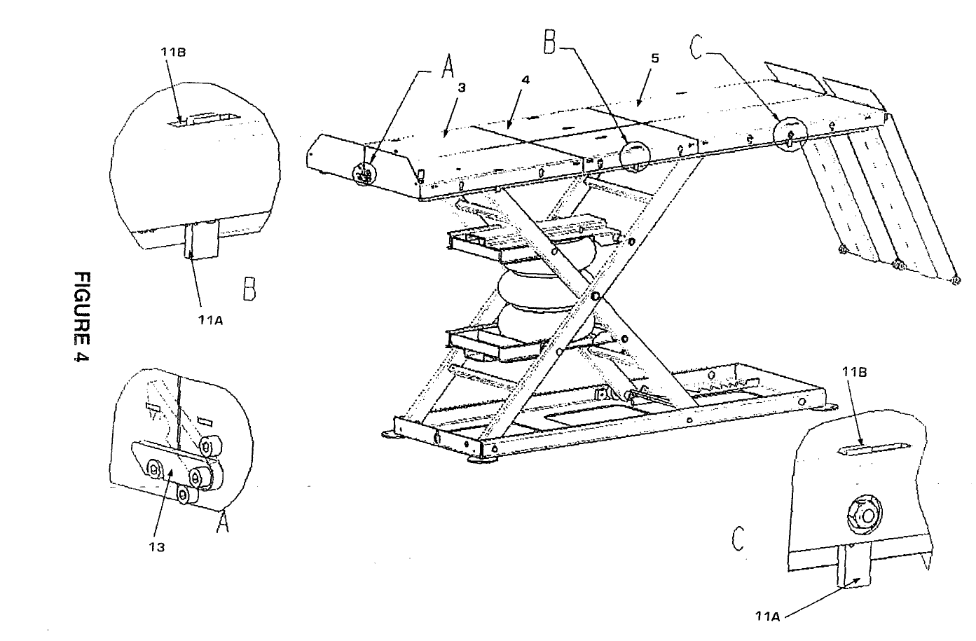

FIG. 4 shows a perspective view of a lifting platform according to the invention, whereby the details of the locking elements have been shown, and

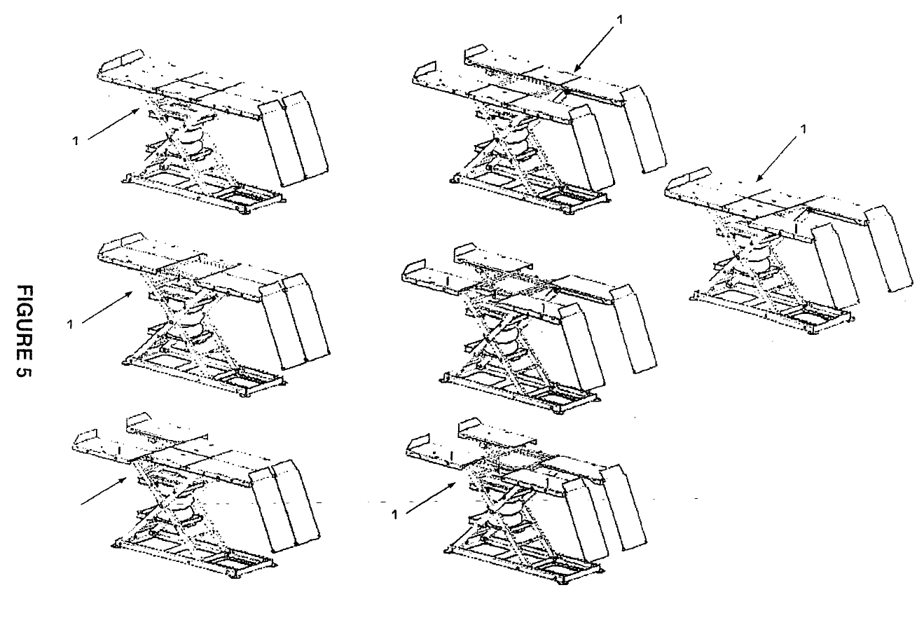

FIG. 5 shows, in the form of diagrammatic views, several examples of configurations that can be occupied by such a lifting platform based on the type of work to be performed on the engine that is placed on such a platform.

As mentioned above, the lifting platform 1, object of the invention, is more particularly designed for the maintenance and repair of light vehicles, such as quad bikes, motorcycles, lawn mower tractors, rototillers, electric cars or the like. In a way that is known in the art, this lifting platform 1 comprises a load-bearing platform and a lift mechanism 2 that acts on the load-bearing platform. This lift mechanism 2 generally consists of a scissor-type structure combined with a device for moving said structure, whereby this driving device can be of pneumatic, hydraulic, electric or another type. It may consist of a jack, a bellows or any other equivalent element. This lift mechanism will not be described in detail below because it is well known to one skilled in the art. Such a mechanism makes it possible to move the platform between a lowered position in which the engine can be situated on said platform to a high position in which the operator carries out maintenance or upkeep on the engine.

The load-bearing platform comes in the form of at least two, generally a number, of decks, shown at 3 to 5, in the figures that work with a support chassis 6. The longitudinal axis of the platform is conventionally viewed in the direction of movement of a vehicle on the surface of said platform. Actually, each time a vehicle is brought onto the platform or conversely is removed from the platform, it moves in a direction viewed over the length of said platform. The longitudinal axis of the platform, shown by XX′ in FIG. 2, therefore extends essentially parallel to the direction of movement of a vehicle on the surface of said platform. It does not matter much whether the vehicle is placed on and removed from the platform by the same end of the platform or by two different ends.

The decks of the platform are mounted to slide on said chassis 6 in a direction T that is transverse to the longitudinal axis XX′ of the platform to constitute an adjustable surface support area. The surface is adjusted by variation of the width of said platform. The decks, constituting the support structure of the vehicle on the platform, thus make it possible, during their sliding movement, in a direction that is orthogonal to the longitudinal axis XX′ of the platform, to clear space 7, 8 for the operator's access either around said platform, when the decks of the platform are in their more compact position, or inside said platform, when, on the contrary, the platform occupies a more spatious position. The position of the decks is selected based on the location of zones for working on the engine. To obtain—in parallel to a variation of the width of the platform—clearing of access zones, these decks are moved to slide in a direction that is transverse or orthogonal to the longitudinal axis of the platform.

In the examples shown, the support chassis 6 comes in the form of a framework that is produced by assembling rails that work with slides 9 with which the sliding mobile decks 3, 4, 5 are equipped. Thus, as FIG. 3 illustrates, each deck is equipped with two sets of slides that are designed to work with rails that are produced from tubular sections of the support chassis 6. Simple traction or thrust on the longitudinal edges of the decks makes it possible to slide the latter along the rails of the support chassis 6. The support chassis 6, because of its production in the form of a hollow structure, allows access to the zone that is left free by the spacing of two decks. The framework of the chassis 6 is formed here by two longitudinal beams and two crosspieces that impart to the framework a general H-shape with a double middle bar when flat. An operator can thus penetrate the zone between the two longitudinal beams until reaching the middle bar of the H.

In the examples that are shown, the platform is formed by six decks in three pairs that move in the same plane. These decks slide along axes that are orthogonal to the longitudinal axis of the platform. Each deck per pair is able to occupy two positions, one, compact, in which said decks of the pair are in contact by their edges, the other, more spatious, in which the decks are separated from one another to provide the spaces 7 with access to the inside of said platform. It is understood that the more the number of decks is multiplied, the higher the number of configurations that can be produced.

In the case of a platform with six decks, as shown, two decks are removable. Each removable deck is positioned between two decks, called stationary end decks. The end decks of one of the pairs constitute a zone for access to said platform.

As mentioned above, the platform therefore consists of removable decks, shown at 4 in the figures, and stationary decks that are shown at 3 and 5 in the figures. The removable decks 4 constitute the median part of the platform and they make it possible—in particular in the case of an arrangement of the decks of the platform in a more spatious position—to have access easily to the median part or below the light engine on which work is to be carried out. Each deck is made from a sheet-metal plate that is equipped with folding lines based on the shape that is imparted to said deck. The end decks 5 of a pair of end decks can be equipped, for example, by extending their outside transverse edge, with access ramps. The other pair of end decks, shown at 3 in the figures, can be equipped with a return along their end transverse edge that constitutes an end-of-travel stop during the introduction of a vehicle onto said platform. The access and the removal of the platform are carried out in this case by the same end of the platform. A vehicle that accesses the platform therefore moves over the same pair of end decks then over the pair of removable intermediate decks then over the second pair of end decks before reaching an end-of-travel stop. The removal of the vehicle from the platform is carried out by reverse motion. These removable mobile decks 3, 5 also comprise an end-of-travel stop 10 that marks the more spatious position of the platform. This end-of-travel stop 10 is delimited here by retraction of the deck to form a wing that is designed to rest against one of the framework elements of the support chassis 6 when the deck slides from the more compact position of the platform to the more spacious position of the platform. Between the support chassis 6 and each mobile deck, at least one element 11 for locked immobilization of the deck on the chassis 6 is also provided. In the examples that are shown, each locking element 11 is formed by a bolt 11A, such as a latch, which pivots and is spring-loaded and works with at least one receiving catch 11B that is located in the deck. In the examples that are shown, this catch 11B is simply formed by a hole 12 that is located in the receiving surface of the deck. The stationary decks comprise a single catch to lock the deck in a more compact position.

Regarding the removable decks 4, the latter conversely comprise two receiving catches 11B that each work with the same locking bolt 11A that is carried by the support chassis 6. Each hole or receiving catch corresponds to one of the end positions that can be occupied by the removable mobile deck 4 during its sliding. The bolt 11A consists of a pivoting latch that is spring-loaded, whereby this spring tends to bring the latch into locked position. It thus is necessary to the operator to act on said latch to bring about the unlocking between support chassis and mobile deck for purposes of safety.

An additional pivoting lever 13, positioned on one of the transverse edges of two end decks of the platform, can also be provided, whereby this pivoting lever makes it possible to make said decks integral with regard to one another when the latter occupy a more compact position.

As mentioned above, the platform of the lifting platform may have different configurations as FIG. 5 illustrates. Thus, it may occupy a more compact position in which the six decks are drawn together and are in contact two by two by their edges. It may also occupy a more spatious position in which the decks of each pair are placed with maximum spacing from one another.

Then, it is possible, between these two end configurations, to select configurations in which two opposing decks are drawn together and occupy a more compact position while the other decks are separated from one another and occupy a more spatious position. It is also possible to obtain new configurations by removing the removable decks that constitute the median part of said platform. Several illustrations of these various configurations have been shown in FIG. 5. Each movement of a deck is carried out by simple thrust or traction on the latter after having caused, if necessary, the latch 11A to pivot to extract it from the corresponding catch 11B that is located in the deck. Consequently, the passage from one configuration to the other of the platform is carried out easily and quickly.

Thanks to all of these possibilities, it is possible to work on wide vehicles or on narrow vehicles and to cover all the necessary work on such vehicles.

1. Lifting platform (1) for the maintenance and repair of light vehicles, such as quad bikes, motorcycles, lawn mower tractors or the like, of the type comprising a load-bearing platform and a lift mechanism (2) that acts on said load-bearing platform, whereby said load-bearing platform, with a longitudinal axis that is viewed in the direction of movement of a vehicle on the surface of said platform, comes in the form of a number of decks (3, 4, 5) that work with a support chassis (6), characterized in that the decks (3, 4, 5) of the load-bearing platform are mobile decks (3, 4, 5), optionally removable, sliding on said chassis (6) in a direction that is orthogonal or transverse to the longitudinal axis of said platform to constitute an adjustable surface support area.

2. Lifting platform (1) according to claim 1, wherein the decks (3, 4, 5) work with the support chassis (6) to bring about, during their movement, parallel to a variation of the overall width of the platform, the clearing of space (7, 8) for access for the operator either around said platform, or inside the platform, based on the location of the zones for working on the engine.

3. Lifting platform (1) according to claim 1, wherein the platform is formed by opposing decks (3, 4, 5) that can move in the same plane so as to occupy two positions, one more compact in which the decks (3, 4, 5) are in contact by their edges, the other more spatious in which the decks (3, 4, 5) are separated from one another to provide space (7) for access to the inside of said platform.

4. Lifting platform (1) according to claim 1, wherein the support chassis (6) comes in the form of a framework that is produced by assembling rails that work with slides (9) with which the sliding mobile decks (3, 4, 5) are equipped.

5. Lifting platform (1) according to claim 1, wherein the platform consists of removable decks (4) and stationary decks (3, 5), whereby the removable decks (4) constitute the median part of the platform.

6. Lifting platform (1) according to claim 1, wherein the stationary mobile decks (3, 5) comprise an end-of-travel stop (10) marking the more spatious position of the platform.

7. Lifting platform according to claim 1, wherein between support chassis (6) and mobile deck (3, 4, 5), at least one locked immobilization element (11) of the deck on the chassis (6) is provided.

8. Lifting platform according to claim 7, wherein each locking element (11) is formed by a bolt (11A), such as a latch, which pivots and is spring-loaded and works with at least one receiving catch (11B) that is located in the deck (3, 4, 5).

9. Lifting platform according to claim 2, wherein between support chassis (6) and mobile deck (3, 4, 5), at least one locked immobilization element (11) of the deck on the chassis (6) is provided.

10. Lifting platform according to claim 3, wherein between support chassis (6) and mobile deck (3, 4, 5), at least one locked immobilization element (11) of the deck on the chassis (6) is provided.

11. Lifting platform according to claim 4, wherein between support chassis (6) and mobile deck (3, 4, 5), at least one locked immobilization element (11) of the deck on the chassis (6) is provided.

12. Lifting platform according to claim 5, wherein between support chassis (6) and mobile deck (3, 4, 5), at least one locked immobilization element (11) of the deck on the chassis (6) is provided.

13. Lifting platform according to claim 6, wherein between support chassis (6) and mobile deck (3, 4, 5), at least one locked immobilization element (11) of the deck on the chassis (6) is provided.
